(19) United States
(12) Patent Application Publication
(10) Pub. No.: US 2017/0299863 A1
(43) Pub. Date: Oct. 19, 2017

(54) REVOLVING MEMBER AND WEARABLE EYEGLASSES WITH THE SAME

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventor: SHU-WEI LUO, Zhengzhou (CN)

(21) Appl. No.: 15/191,485

(22) Filed: Jun. 23, 2016

(30) Foreign Application Priority Data
Apr. 19, 2016 (CN) 201610243514.9

(51) Int. Cl. G02B 27/01

(52) U.S. Cl. CPC G02B 27/0149; G02B 2027/0159; G02B 2027/0169

(57) ABSTRACT

A revolving member of a wearable device includes a first holder, a second holder, a shaft, and a limiting element. The second holder is rotatably coupled to the first holder. The shaft is coupled to the first holder and the second holder. The limiting element is arranged on a first end of the shaft and is coupled to the first holder and the second holder. When the first holder is driven by an external force to rotate around the shaft toward the second holder, the limiting element limits a rotatable angle between the second holder and the first holder.

### CROSS-REFERENCE TO RELATED APPLICATIONS

This application claims priority to Chinese Patent Application No. 201610243514.9 filed on Apr. 19, 2016, the contents of which are incorporated by reference herein.

### FIELD

The subject matter herein generally relates to wearable devices, and more particularly to wearable eyeglasses and a revolving member of the wearable eyeglasses.

### BACKGROUND

Wearable eyeglasses are popular because users can use them to listen to music, watch videos, or make calls. However, current cantilevers of the wearable eyeglasses limit to adjust optical displays of the wearable eyeglasses, which can cause inconvenience for user to use the wearable eyeglasses.

### BRIEF DESCRIPTION OF THE DRAWINGS

Implementations of the present technology will now be described, by way of example only, with reference to the attached figures, wherein:

FIG. 1 is a diagrammatic view of one embodiment of a wearable eyeglass.

FIG. 2 is a diagrammatic view of one embodiment of a cantilever of the wearable eyeglass as in FIG. 1.

FIG. 3 is a diagrammatic view of one embodiment of a revolving member of the cantilever as in FIG. 2.

FIG. 4 is a sectional view of the revolving member as in FIG. 3.

FIG. 5 is an exploded isometric view of the revolving member as in FIG. 3.

FIG.6 is a diagrammatic view of one embodiment of the revolving member in a first state.

FIG.7 is a diagrammatic view of one embodiment of the revolving member in a second state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a gap on of a region is partially contained within a boundary formed by the object. The term “substantially” is defined to be essentially conforming to the particular dimension, shape or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a wearable eyeglass with a revolving member. The revolving member includes a first holder, a second holder, a shaft, and a limiting element. The second holder is rotatably coupled to the first holder. The shaft is coupled to the first holder and the second holder. The limiting element is arranged on a first end of the shaft and coupled to the first holder and the second holder. When the first holder is driven by an external force to rotate around the shaft toward the second holder, the limiting element limit a rotatable angle of the second holder inclined to first holder.

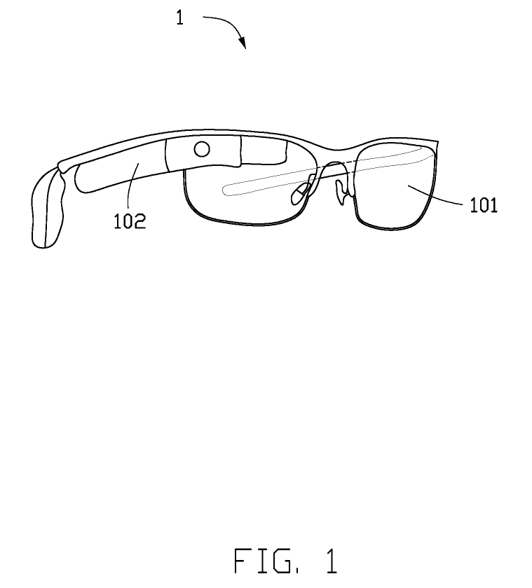

FIG. 1 illustrates one embodiment of a wearable eyeglass. The wearable eyeglass 1 includes an eyeglass body 101 and a cantilever 102 of the wearable eyeglass 1 (hereinafter “wearable eyeglass cantilever”). The wearable eyeglass cantilever 102 is fixed on the eyeglass body 101.

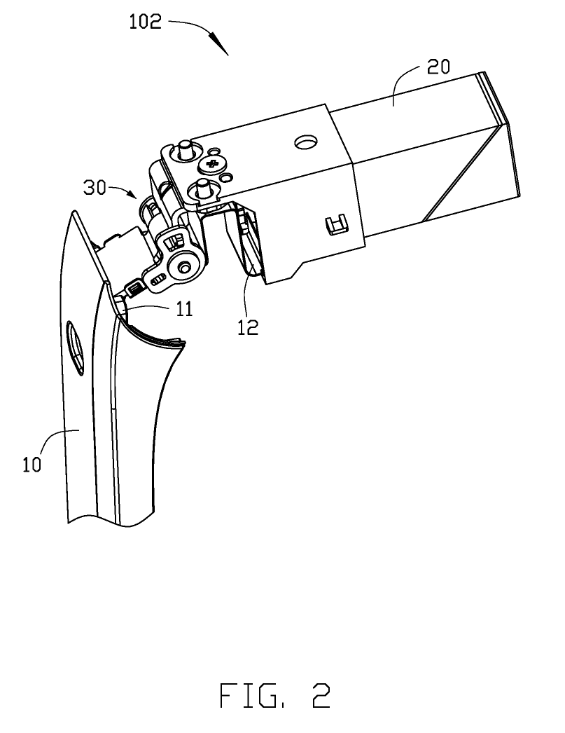

FIG. 2 illustrates the wearable eyeglass cantilever 102. The wearable eyeglass cantilever 102 includes a cantilever body 10 and a display device 20 coupled to the cantilever body 10. The cantilever body 10 is fixed on the eyeglass body 101 (shown in FIG.1). The display device 20 is used to display information to users, such as a user interface. In the embodiment, the display device 20 is made of a prism. The cantilever body 10 includes a motherboard circuit 11. The display device 20 includes a signal transmission line 12. The signal transmission line 12 connects to the motherboard circuit 11. Thereby, the motherboard circuit 11 can communicate with the display device 20 by the signal transmission line 12.

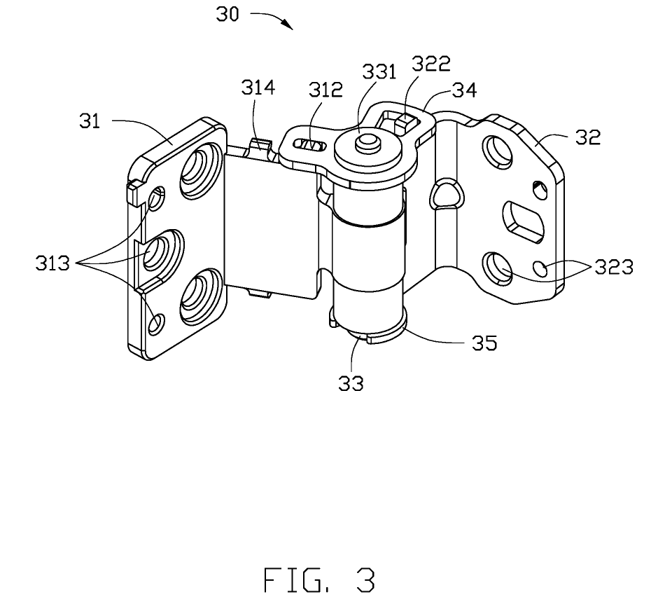

FIG. 3 illustrates a revolving member 30 of the cantilever 102. The display device 20 is rotatably arranged on the cantilever body 10 by the revolving member 30. That is, a user can rotate the revolving member 30 to adjust angles of the display device 20 to the cantilever body 10, thus providing the user with the most comfortable visual experience.

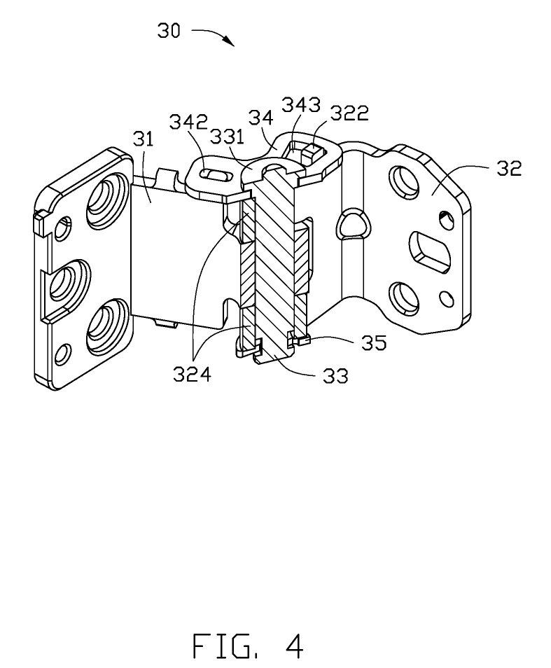

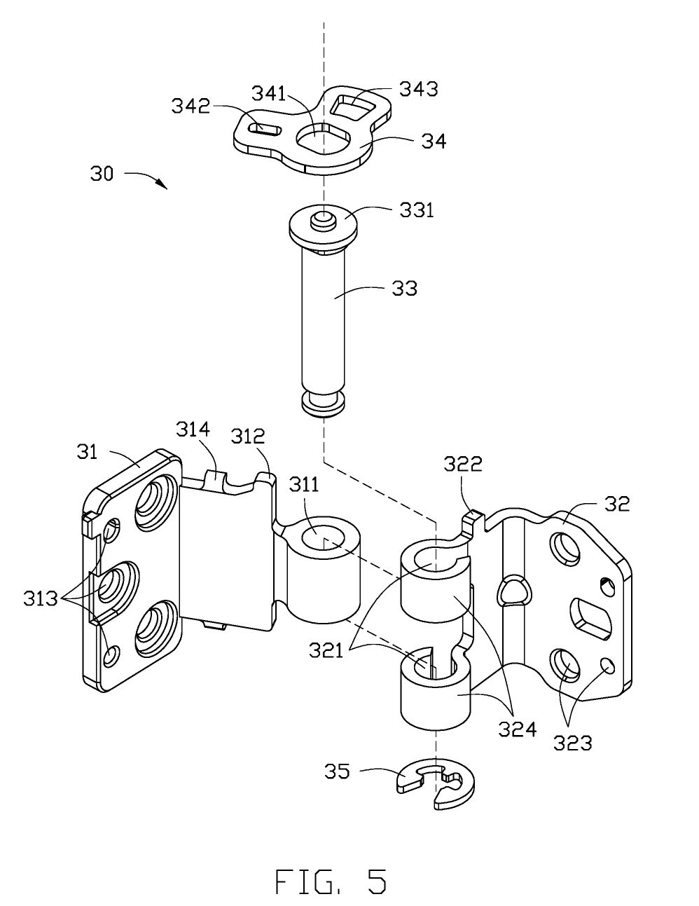

FIGS. 4-5 further illustrate the revolving member 30 of the cantilever 102. The revolving member 30 includes a first holder 31, a second holder 32, a shaft 33, and a limiting element 34. The first holder 31 rotatably connects to the second holder 32 by the shaft 33. The limiting element 34 is arranged on a first end of the shaft 33 and couples to the first holder 31 and the second holder 32. The limiting element 34 can limit a rotatable angle of the first holder 31 inclined to the second holder 32 when the second holder 32 is driven by an external force to rotate around the shaft 33 toward the first holder 31.

The first holder 31 includes a number of first mounting holes 313. The second holder 32 also includes a number of second mounting holes 323. The first holder 31 is arranged on the cantilever body 10 by the first mounting holes 313. The second holder 32 is arranged on the display device 20 by the second mounting holes 323. In the embodiment, the first holder 31 is mounted on the cantilever body 10 when screws (not shown) pass through the first mounting holes 313 and lock onto the cantilever body 10. The second holder 32 is mounted on the display device 20 when screws (not shown) pass through the second mounting holes 323 and lock on the display device 20.

Referring to FIG. 5, the shaft 33 includes a holding portion 331. The holding portion 331 is mounted on the first end of the shaft 33. The first holder 31 includes at least one first through hole 311. The second holder 32 includes at least one second through hole 321.

The revolving member 30 further includes a holding element 35. A second end of the shaft 33 passes through the at least one first through hole 311 and at least one second through hole 321, and then connects to the holding element 35. The first holder 31 is rotatably coupled to the second holder 32 by the shaft 33. The first holder 31 and the second holder 32 are sandwiched between the holding portion 331 and the holding element 35. In the embodiment, the shaft 33 is coupled to the first through hole 311 and the second through hole 321 by an interference fit, thus any angle can be formed between the first holder 31 and the second holder 32 without an external force when the first holder 31 is coupled to the second holder 32 by the shaft 33. The holding element 35 is substantially E shaped. The second end of the shaft 33 is connected to, for example a clip in the E shaped holding element 35.

Referring to FIG. 5, in the embodiment, the second holder 32 includes two second through holes 321. A side of the second holder 32 includes two protruding portions 324. One protruding portion 324 curls up around a first direction to form a second through hole 321, another protruding portion 324 curls up around a second direction to form a second through hole 321, and the first direction is opposite to the second direction, which makes the revolving member 30 more stable.

The two protruding portions 324 are respectively located at an upper end or a lower end on the same side of the second holder 32. A distance between the two protruding portions 324 equals to or is greater than a depth of the first through hole 311. The first through hole 311 locates between the two second through holes 321. A way of coupling the first holder 31 to the second holder 32 by the shaft 33 is: the second end of the shaft 33 firstly passes through one of the second through hole 321, then passes through the first through hole 311, and lastly passes through the other second through hole 321.

Referring to FIGS. 3 and 4, the limiting element 34 is arranged on the first end of the shaft 33 and is sandwiched between the holding portion 331 and the second through hole 321. The limiting element 34 includes a first receiving hole 342 and a second receiving hole 343. The first holder 31 includes a first lug 312 corresponding to the first receiving hole 342. The second holder 32 includes a second lug 322 corresponding to the second receiving hole 343. The first lug 312 can be received in the first receiving hole 342. In an alternative embodiment, the first lug 312 further can move in the first receiving hole 342. The second lug 322 can be received in the second receiving hole 343 and can move in the second receiving hole 343. In the illustrated embodiment, the limiting element 34 includes a third through hole 341. The shaft 33 firstly passes through the third through hole 341, and then passes through the second through hole 321 and the first through hole 311. Thereby, the limiting element 34 is fixed on the shaft 33.

The first holder 31 further includes a block portion 314. The limiting element 34 is stuck between the block portion 314 and the first lug 312 when the first lug 312 is received in the first receiving hole 342, which restricts the first lug 312 to stay in the first receiving hole 342.

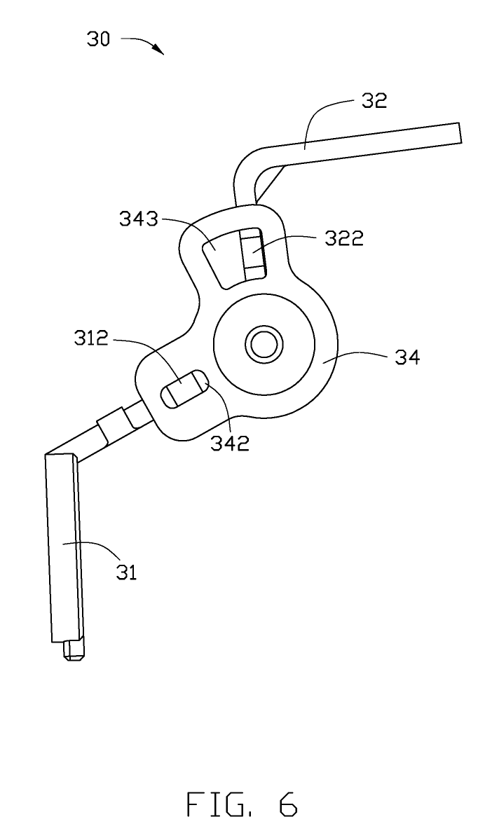

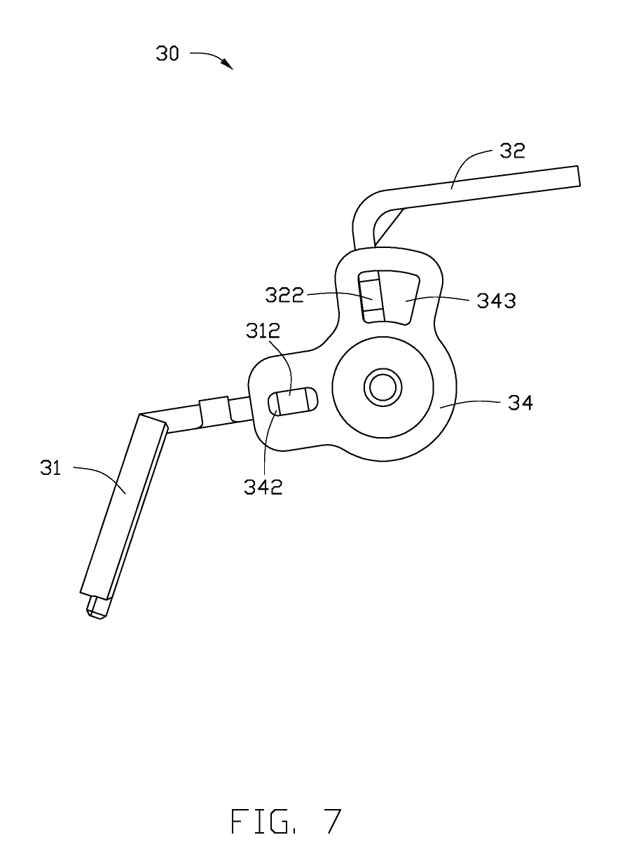

The second receiving hole 343 is substantially sector shaped. The second lug 322 can be driven by an external force to move in the second receiving hole 343. The sector shaped is formed in the second receiving hole 343 with an angle that equals to the rotational angle of the second holder 32 with respect to the first holder 31. The angle of the sector can be set according to users' needs. In the embodiment, the angle of the second receiving hole 343 is 20 degrees. FIG.6 illustrates the revolving member 30 in a first state. FIG. 7 illustrates the revolving member 30 in a second state. As shown in FIGS. 6 and 7, the angle of the second holder 32 to the first holder 31 is 20 degrees when the state of the revolving member 30 changes from the first state to the second state.

The embodiments shown and described above are only examples. Many details are often found in the art such as the other features of a wearable device 1. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A revolving member comprising:
a first holder;
a second holder rotatably coupled to the first holder;
a shaft coupled to the first holder and the second holder; and
a limiting element arranged on a first end of the shaft and coupled to the first holder and the second holder;
wherein when the first holder is driven by an external force to rotate around the shaft toward the second holder, the limiting element limits a rotatable angle between the second holder and the first holder.

2. The revolving member according to claim 1, wherein the shaft comprises a holding portion mounted on a first end of the shaft; the first holder comprises a first through hole; the second holder comprises at least one second through hole; a second end of the shaft opposite to the first end passes through the first through hole and the at least one second through hole to rotatably couple the first holder and the second holder; and the shaft is coupled to the first through hole and the second through hole by an interference fit.

3. The revolving member according to claim 2, wherein the limiting element comprises a third through hole; the second end of the shaft passes through the third through hole; and the limiting element is sandwiched between the holding portion and the second holder.

4. The revolving member according to claim 2, further comprising a holding element; wherein the shaft passes through the first through hole and the at least one second through hole, and the shaft couples to the holding element.

5. The revolving member according to claim 4, wherein the holding element is substantially E shaped; and the second end of the shaft is coupled to the holding element.

6. The revolving member according to claim 5, wherein a side of the second holder comprises at least one protruding portion; and the least one protruding portion curls up around a direction to form a second through hole.

7. The revolving member according to claim 5, wherein the second holder comprises two second through holes; a side of the second holder comprises two protruding portions; one protruding portion curls up around a first direction to form a second through hole; the other protruding portion curls up around a second direction to form the other second through hole; and the first direction is opposite to the second direction.

8. The revolving member according to claim 1, wherein the first holder comprises a first lug; the second holder comprises a second lug; the limiting element comprises a first receiving hole and a second receiving hole; the first receiving hole corresponds to and receives the first lug, the first receiving hole limits a motion of the first lug therein; the second receiving hole corresponds to and receives the second lug, and the second receiving hole limits a motion of the second lug therein.

9. A cantilever of a wearable eyeglass, the cantilever comprising:
a cantilever body;
a revolving member; and
a display device rotatably coupled to the cantilever body by the revolving member;
wherein the revolving member comprises:
a first holder;
a second holder rotatably coupled to the first holder;
a shaft coupled to the first holder and the second holder; and
a limiting element arranged on a first end of the shaft and coupled to the first holder and the second holder;
wherein when the first holder is driven by an external force to rotate around the shaft toward the second holder, the limiting element limits a rotatable angle between the second holder and the first holder.

10. The cantilever according to claim 9, wherein the shaft comprises a holding portion mounted on a first end of the shaft; the first holder comprises a first through hole; the second holder comprises at least one second through hole; a second end of the shaft opposite to the first end passes through the first through hole and the at least one second through hole to rotatably couple the first holder and the second holder; and the shaft is coupled to the first through hole and the second through hole by an interference fit.

11. The cantilever according to claim 10, wherein the limiting element comprises a third through hole; the second end of the shaft passes through the third through hole; and the limiting element is sandwiched between the holding portion and the second holder.

12. The cantilever according to claim 10, wherein the revolving member further comprises a holding element; the shaft passes through the first through hole and the at least one second through hole, and the shaft couples to the holding element.

13. The cantilever according to claim 12, wherein the holding element is substantially E shaped; and the second end of the shaft is coupled to the holding element.

14. The cantilever according to claim 13, wherein a side of the second holder comprises at least one protruding portion; and the least one protruding portion curls up around a direction to form a second through hole.

15. The cantilever according to claim 13, wherein the second holder comprises two second through holes; a side of the second holder comprises two protruding portions; one protruding portion curls up around a first direction to form a second through hole; the other protruding portion curls up around a second direction to form the other second through hole; and the first direction is opposite to the second direction.

16. The cantilever according to claim 9, wherein the first holder comprises a first lug; the second holder comprises a second lug; the limiting element comprises a first receiving hole and a second receiving hole; the first receiving hole corresponds to and receives the first lug; the first receiving hole limits a motion of the first lug therein; the second receiving hole corresponds to and receives the second lug; and the second receiving hole limits a motion of the second lug therein.

17. A wearable eyeglass comprising:
an eyeglass body; and
a cantilever, comprising:
a cantilever body fixed on the eyeglass body;
a revolving member; and
a display device rotatably coupled to the cantilever body by the revolving member;
wherein the revolving member comprises:
a first holder;
a second holder rotatably coupled to the first holder;
a shaft coupled to the first holder and the second holder; and
a limiting element arranged on a first end of the shaft and coupled to the first holder and the second holder;
wherein when the first holder is driven by an external force to rotate around the shaft toward the second holder, the limiting element limits a rotatable angle between the second holder and the first holder.

18. The wearable eyeglass according to claim 17, wherein the shaft comprises a holding portion mounted on a first end of the shaft; the first holder comprises a first through hole; the second holder comprises at least one second through hole; a second end of the shaft opposite to the first end passes through the first through hole and the at least one second through hole to rotatably couple the first holder and the second holder; the shaft is coupled to the first through hole and the second through hole by an interference fit.

19. The wearable eyeglass according to claim 18, wherein the limiting element comprises a third through hole; the second end of the shaft passes through the third through hole; and the limiting element is sandwiched between the holding portion and the second holder.

20. The wearable eyeglass according to claim 18, wherein the revolving member further comprises a holding element; the shaft passes through the first through hole and the at least one second through hole, and the shaft couples to the holding element.
